(19) United States
(12) Patent Application Publication
(10) Pub. No.: US 2008/0273223 A1
(43) Pub. Date: Nov. 6, 2008

(54) Intelligent print/copy management system

(75) Inventors: Yao-Lu Tsai, Taipei (TW); Tzu-Kai Hsiau, Taipei (TW); Tsung-Han Tsai, Hsinchu (TW); Shih-Liang Chang, Hsinchu (TW); Bo-Bo Wang, Hsinchu (TW); Chun-Yu Chang, Hsinchu (TW)

Correspondence Address: BIRCH STEWART KOLASCH & BIRCH, PO BOX 747, FALLS CHURCH, VA, 22040-0747, US

(73) Assignee: KCodes Corporation Aetas Systems Incorporated

(21) Appl. No.: 11/797,461

(22) Filed: May 3, 2007

(51) Int. Cl. G06F 3/12

(52) U.S. Cl. 358/1.15

(57) ABSTRACT

An intelligent print/copy management system includes group of computers, an Intranet environment, a print server/MFP server and a printer/MFP; software management function being added into the print/MFP for print server/MFP server to provide basic statistic analysis, monitor and control, and/or security alert while receiving print command from the computer to drive the printer, MFP or scanner to operate thus for a business to manage and specify output functions from printer, MFP, or scanner and further to achieve more efficient print/copy output operation.

### FIELD OF THE INVENTION

The present invention relates to an intelligent printing/copying management system, and more particularly, to one applied in print server or MFP server to provide basic statistical analysis, monitor and control, and security alert functions.

### BACKGROUND OF THE INVENTION

It is very common for many computers to share the same printer via Intranet in the current office environment and two most popular shared configurations are described below:

Referring to FIG. 1 for a configuration of shared printer of the prior art, Computer A 12 is directly connected to a printer 11 and driver needed by the printer 11 is loaded into Computer A 12 while shared print function is activated in Computer A 12; meanwhile, Computer B 14, Computer C 15, and Computer D 16 may be linked to Computer A 12 via the Intranet environment to print out by having Computer A 12 to drive the printer 11. However, the configuration of the prior art as described above though may realize the shared print function, the following problems and insufficiencies do exist:
1. Computer A given with the function of shared print must be in the status of power on, or the on-line print function is not available.
2. The simple on-line shared mode fails effective expansion under the configuration, which at its best is only good for user by a small office or users at home.
3. The operator assigned to the use of Computer A must be responsible at the same time for the management or exclude problems generated in the course of on-line print.
4. The work efficiency of Computer A is affected by on-line print.

To correct those problems as list above, another configuration has been developed as illustrated in FIG. 2 for another configuration of shared printer of the prior art. As illustrated, Computer A in the first configuration of the shared print of the prior art is substituted with print server/MFP server 21 for the print server/MFP server 21 to be linked via the Intranet environment 22 to multiple units of printers 23, MFPs 24, and/or scanners 25. Given with management classification function, the print server/MFP server 21 allows a user computer 26 to define with the printer 23 or the MFP 24 selection or segregation status thus to create multiple groups of print for each printer 23 or MFP 24 to permit on-line print by multiple units of computer 26 at the same time. If the user finds out that the preset printer or MFP is damaged, flexible selection of another printer or MFP with the print server/MFP server is available.

Use of the print server/MFP server to achieve the object of print for providing easy setup, low cost, flexible applications and free of wiring distribution has become the top choice to the business in establishing of computer and its peripherals. However, the configuration of the shared print of the prior using the print server/MFP server is still observed with the following deficiencies:
1. Whereas the print server/MFP server of the prior art does not provide function of basic statistic analysis to effectively record and compile form, quantity, and type (color or B/W) of the file printed; it fails to provide effective management information to an administrator.
2. Whereas the print server/MFP server of the prior art does not provide monitor and control functions, it fails to restrict unauthorized or illegal on-line use, or to effectively control printout amount or usable time by each computer.
3. Whereas the print server/MFP server of the prior art does not provide security alert function, it fails to respond with strategies against any improper use, use at improper time, improper user, or improper operation (e.g., massive printouts of the same image).

### SUMMARY OF THE INVENTION

A primary object of the present invention is to provide an intelligent print/copy management system that adds more management functions to a print server/MFP server for improved management and operation efficiency of a printer, MFP or scanner.

Another object of the present invention is to provide an intelligent print/copy management system that enables a print server/MFP server to effectively record and compile statistics on file form, quantity, and type (color or B/W) of the printout by each computer to deliver effective management information for the administrator.

Another object yet of the present invention is to provide an intelligent print/copy management system that enables a print server/MFP server to perform monitor and control functions to prevent unauthorized or illegal on-line user to access to the printer and to effectively control the printout amount or usable time for printout by computer.

Another object yet of the present invention is to provide an intelligent print/copy management system that adds security alert function to a print server/MFP server by executing responsive strategies thus to specify each user in the event of any use at improper time, use by improper user, or improper operation (e.g., massive printouts of the same image).

Another object yet of the present invention is to provide an intelligent print/copy management system that allows a business to save costs incurred from use, maintenance or purchased HD including printer and/or MFP and from purchased consumption items of paper and ink.

To achieve the above and other objects, a configuration of an intelligent print/copy management system of the present invention includes a group of computers, an intranet environment, a printer server/MFP server, and a printer/MFP; software management functions are added into the print server/MFP server for print server/MFP server to provide basic statistic analysis, monitor and control, and/or security alert while receiving print command from the computer to drive the printer, MFP or scanner to operate thus for a business to manage and specify output functions from printer, MFP, or scanner and further to achieve more efficient print/copy output operation.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block chart showing a first configuration of a shared printer of the prior art;

FIG. 2 is a block chart showing a second configuration of a shared printer of the prior art;

FIG. 3 is a block chart showing a configuration of an intelligent print/copy management system of the present invention;

FIG. 4A is a block chart showing a configuration of the present invention in executing basic statistic analysis function;

FIG. 4B is a block chart showing another configuration of the present invention in executing basic statistic analysis function;

FIG. 5A is a block chart showing a configuration of the present invention in executing monitor and control functions;

FIG. 5B is a block chart showing another configuration of the present invention in executing monitor and control functions; and

FIG. 6 is a block chart showing a configuration of the present invention in executing security alert function.

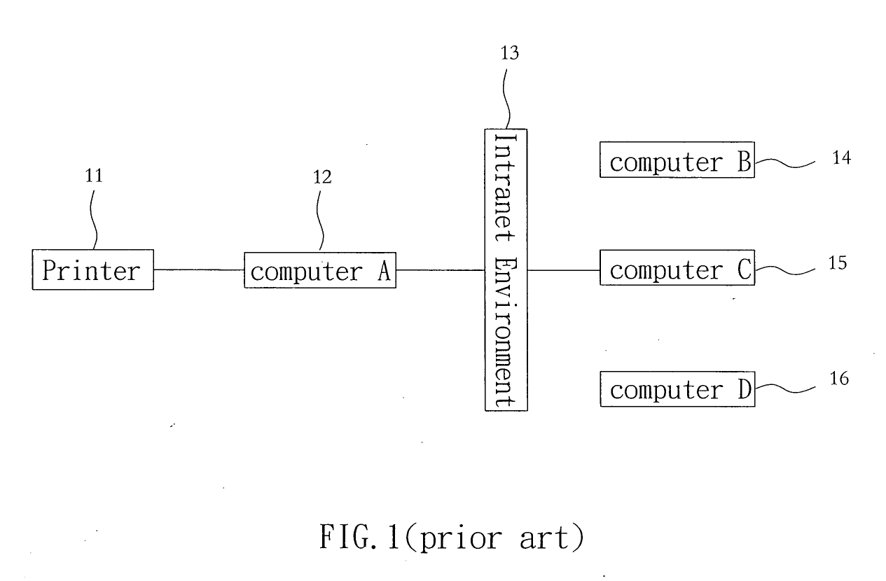

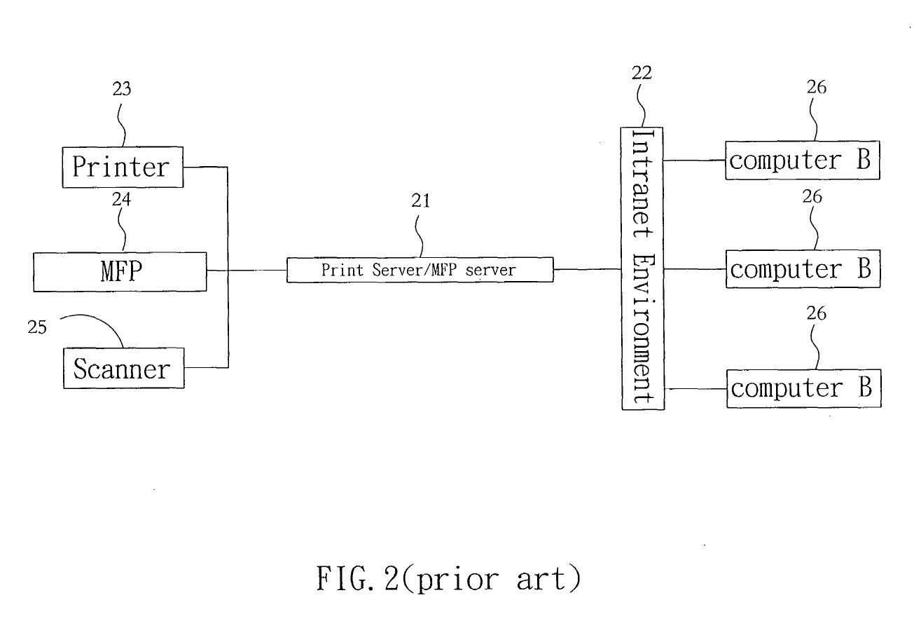

### DETAILED DESCRIPTION OF THE PREFERRED EMBODIMENTS

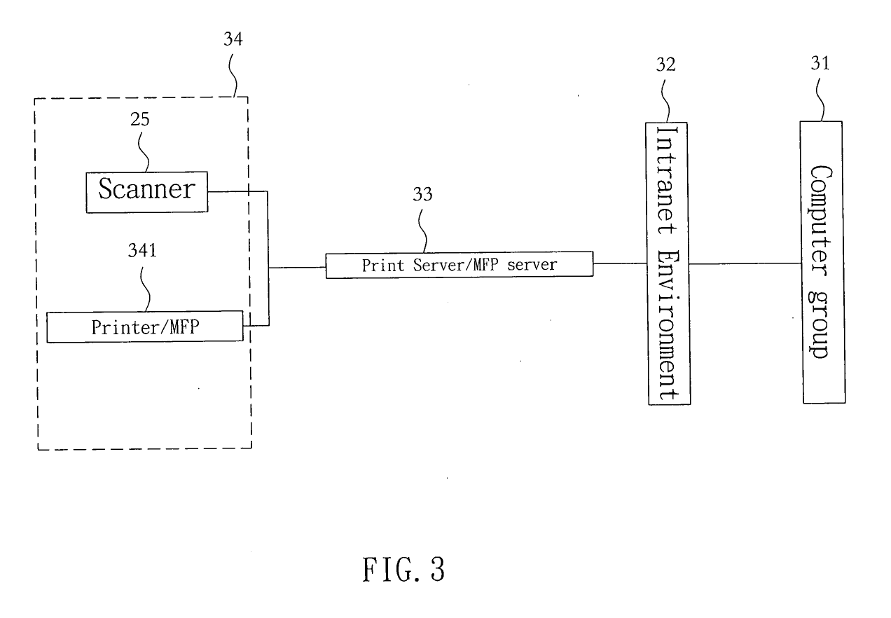

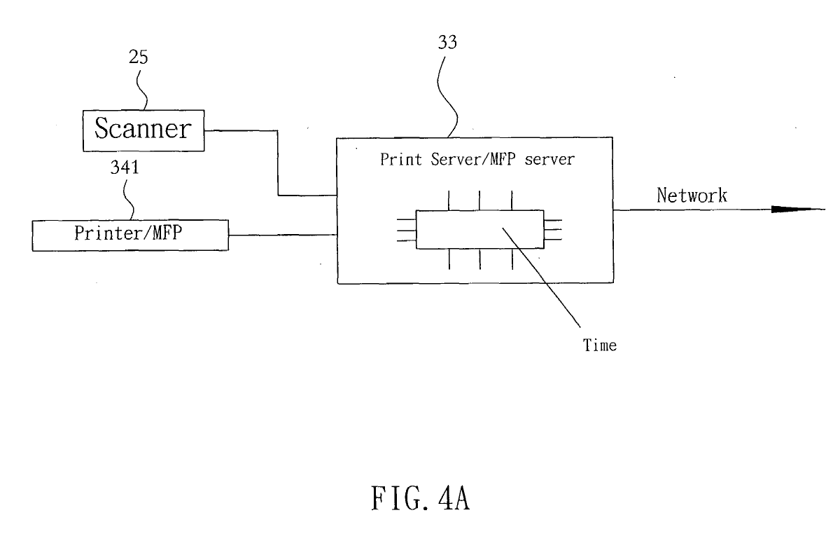

Referring to FIG. 3 for a configuration of an intelligent print/copy management system of the present invention, the configuration includes:

A computer group 31 comprised of multiple user computers, which are connected via an Intranet environment 32 to a Print Server/MFP Server 33;

the Intranet environment 32 comprised of server, hub, and network cabling with the hub provided for connection by the computer group 31 and connection to the print server/MFP server 33;

the print server/MFP server 33 having been added with software management functions for providing basic statistic analysis, monitor and control, and/or security alert functions while receiving computer print commands to drive the printer/MFP or a scanner 34 to operate; and

the printer/MFP or scanner 34 to receiver control signals inputted by the print server/MFP server 33 to execute the functional operation as called for.

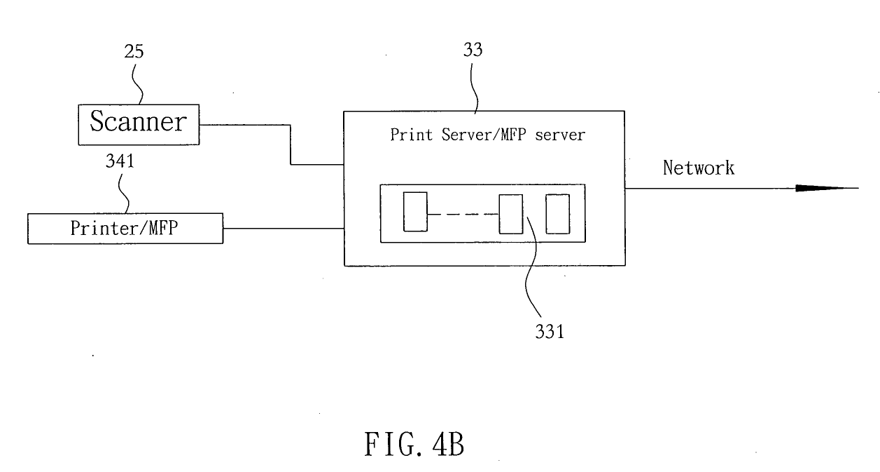

Now referring to FIG. 4A for a configuration of performing basic statistic analysis by the intelligent print/copy management system of the present invention; to achieve the purpose of performing basic statistic analysis function, the print server/MFP server 33 must be able to control accurate and real time (including year, month, day, hour, minute, and second) and the time can be obtained by any of the following methods:
1. From any server that provides correct time through Internet;
2. Setting up the time upon installing the driver, followed with periodical synchronization; or
3. Time message to be delivered from the printer end while printing.

In any of the methods describe above, adding real time into the print server/MFP server helps the practice of print management.

As illustrated in FIG. 4 B for another configuration of the intelligent print/copy management system of the present invention in executing its function of basic statistic analysis, the print server/MFP server 33 includes a non-volatile style memory 331 for the storage of user records and its build-in log function includes:
1. To log in Job/Page IP and time to start print, number of color/BW printout pages (Source/Destination files), toner coverage and other print or scan related information;
2. To periodically print out original or statistic data or upload data to a administrator server; and
3. To provide one or a plurality of buffer with one to log in the current use records (by year, month, and week) while the rest of the buffers are for storage of prior use records.

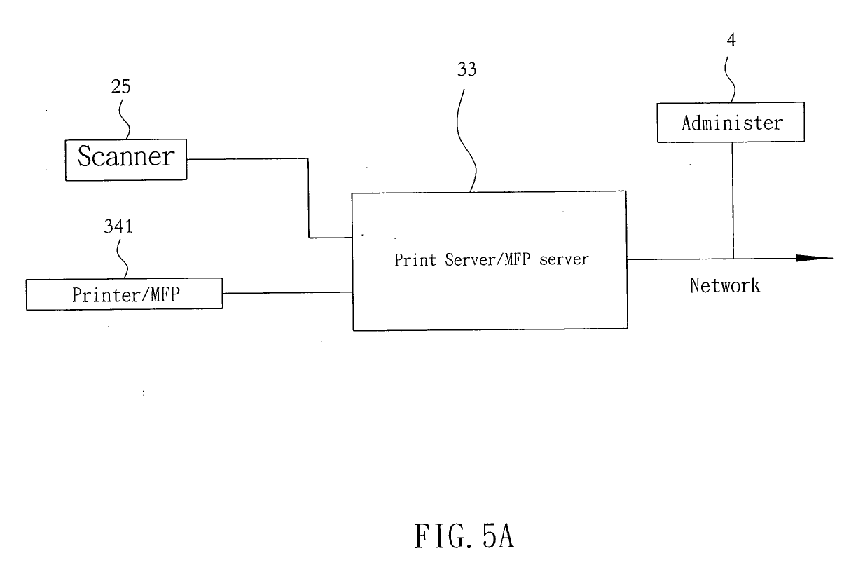

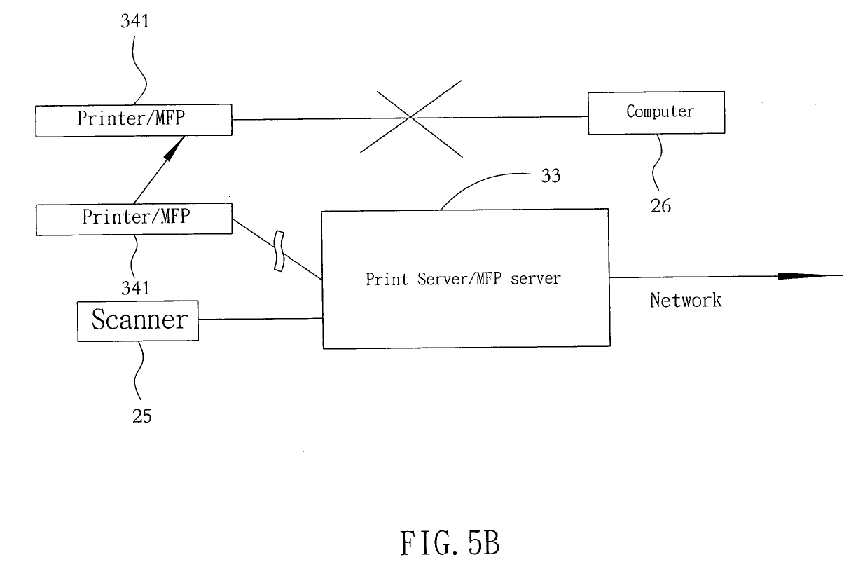

As illustrated in FIG. 5A for a configuration for the intelligent print/copy management system to perform monitor and control functions, the print server/MFP server 33 is capable of providing an network administrator 4 to control and manage the print and scan authorization including but not limited to the following functions:
1. Only the one approved is authorized to access color print/copy and scan functions;
2. Control of the amount allowed to the authorized user by the administrator; and
3. Prescribe limited time of use to prevent print/copy/scan for personal purpose during off office hours.

FIG. 5B shows another configuration of the intelligent print/copy management system of the present invention in executing monitor and control functions, the print server/MFP server 33 in conjunction with the printer/MFP 341 is capable of preventing use failing to comply with operation rules by defining settings. Settings are defined as follows:
1. Record the time at the moment of the power is interrupted or unplug while recording the time when the print server/MFP server is activated again; and
2. Upon installing the printer/MFP, it is set that the printer/MPF can only be used through the print server/MFP server.

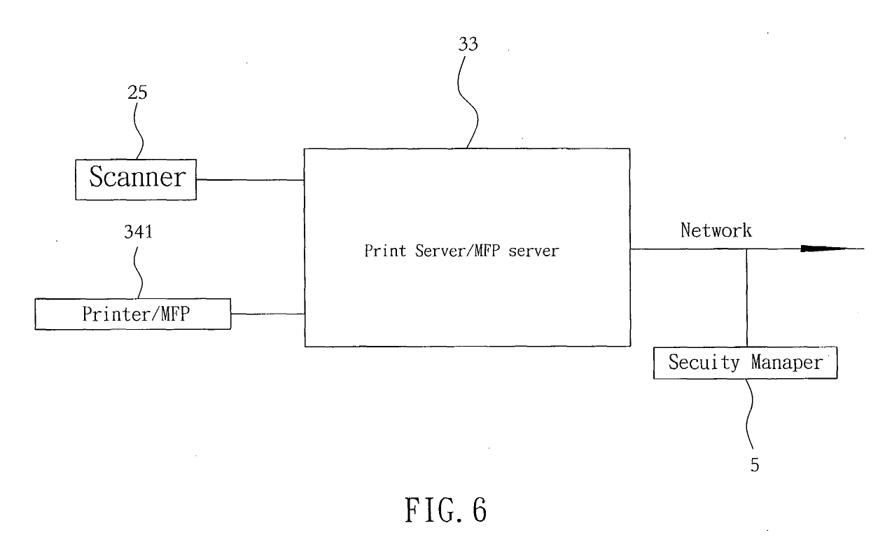

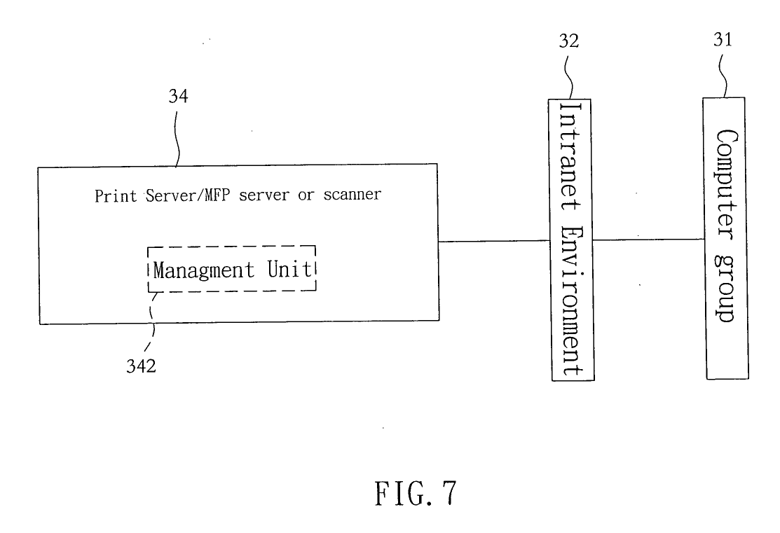

As illustrated in FIG. 6 for a configuration of the intelligent print/copy management system of the present invention in performing security alert function, when any condition of time of use, user, or operation contents is qualified with the system setup (e.g., massive and repeated print of negotiable securities or the document printed by a certain high-ranking official), the print server/MFP server 33 takes the initiative to compress (JBIG) or encode (PDF) data scan or print while logging in the time of the event, real-time uploading the related information to a security manager 5 computer, and restrict data uploading or printing/copying. Furthermore, alert information is sent to the security manager 5 via the network. The security manager 5 is allowed to have real-time monitor of the use status via network and may preserve the compressed image and related records of use for future reference in case of any abnormal status.

In another configuration of the intelligent print/copy management system of the present invention as illustrated in FIG. 7, a management unit 342 equivalent to the printer serve/MFP server is disposed in the printer/MFP or scanner 34 to provide basic statistic analysis and/or security alert while receiving the print command from the computer to drive the printer/MFP or scanner 34 to operate. The management unit 342 may be related to a chip set or storage software in a storage object.

What is claimed is:

1. An intelligent print/copy management system includes:
a computer group linked to at least one printer/MFPs through a network configuration; and
a management means disposed in the printer/MFP for receiving print signal from one of the computer group to drive the intelligent print/copy management system,
wherein the management means comprises at least one function selected from the group consisting of statistic analysis, monitor, control, and security alert.

2. The intelligent print/copy management system as claimed in claim 1, wherein the management means comprises a real time function, and the real time is provided from one of the computer group via the network configuration.

3. The intelligent print/copy management system as claimed in claim 1, wherein the statistic analysis comprises at least one function selected from the group consisting of recording log on/off time of the computer by user, recording the number of color/BW printout/scanning pages, and recording toner coverage.

4. The intelligent print/copy management system as claimed in claim 1, wherein the monitor and control functions allow the management means to provide the administrator of the network configuration to execute control and management of print and scan authorization.

5. The intelligent print/copy management system as claimed in claim 1, wherein the management means registers the time of power interruption or unplug and the time when the system is activated once again.

6. The intelligent print/copy management system as claimed in claim 1, wherein the security alert function further comprises:
compressing or encoding print or scan data when any condition of time of use, user or operation contents is qualified with the system setup;
recording the time of the event;
uploading related information to a manager computer; and
restricting the system to upload, print or copy.

7. An intelligent print/copy management system includes:
at least one printer/MFP;
a computer group linked to the printer/MFP via a network configuration; and
a print server/MFP serve linked to the printer/MFP,
wherein a management unit disposed in the printer/MFP provides at least one function of statistic analysis, monitor and control, and security alert for the print server/MFP service.

8. The intelligent print/copy management system as claimed in claim 7, wherein the management unit provides a real time function, and the real time is provided from one of the computer group via the network configuration.

9. The intelligent print/copy management system as claimed in claim 7, wherein the management unit is provided with real time; and the real time is set up followed with periodical synchronization upon installing a driver to the print server/MFP server.

10. The intelligent print/copy management system as claimed in claim 7, wherein the management unit is provided with real time function with the real time available from a time message delivered from any one of the computer group upon printing.

11. The intelligent print/copy management system as claimed in claim 7, wherein the print server/MFP server further includes a non-volatile random access memory (NVRAM) to store use records.

12. The intelligent print/copy management system as claimed in claim 11, wherein the NVRAM is capable of recording IP address and time of use for any printout from the computer group.

13. The intelligent print/copy management system as claimed in claim 11, wherein the NVRAM is capable of recording number of color/BW print pages or any source file of print/scan from the computer group.

14. The intelligent print/copy management system as claimed in claim 11, wherein the NVRAM is capable of recording the toner coverage of the printer/MFP.

15. The intelligent print/copy management system as claimed in claim 7, wherein the print server/MFP server provides any of the computer group to execute control of print/scan.

16. The intelligent print/copy management system as claimed in claim 7, wherein a register is further disposed to the management unit to register the time of power interruption or unplug and register the time when the system is activated once again.

17. The intelligent print/copy management system as claimed in claim 7, wherein a alert installation is further included in the system to compress or encode print/scan data while transmitting real-time compressed or encoded data to any of the computer group.

18. The intelligent print/copy management system as claimed in claim 7, wherein any of the computer group is capable of restricting or eliminating print/scan executed at any other of the computer group.

19. The intelligent print/copy management system as claimed in claim 7, wherein the management unit is a chip set.

20. An intelligent print server/MEP server for driving a printer/MFP has a management means disposed in the print server/MFP server to compile and manage the print/MFP.
